(19) United States
(12) Patent Application Publication
(10) Pub. No.: US 2024/0187751 A1
(43) Pub. Date: Jun. 6, 2024

(54) Pixel Circuit Having Dynamically Controlled Conversion Gain

(71) Applicant: OmniVision Technologies, Inc., Santa Clara, CA (US)

(72) Inventors: Hiroki Ui, Yokohama (JP); Eiichi Funatsu, San Jose, CA (US)

(73) Assignee: OmniVision Technologies, Inc., Santa Clara, CA (US)

(21) Appl. No.: 18/359,934

(22) Filed: Jul. 27, 2023

Related U.S. Application Data
(60) Provisional application No. 63/386,004, filed on Dec. 5, 2022.

(51) Int. Cl. H04N 25/51; H04N 25/59; H04N 25/771

(52) U.S. Cl. CPC H04N 25/51; H04N 25/59; H04N 25/771

(57) ABSTRACT

The pixel circuit of the image sensor includes one or more photoelectric conversion elements that generates charges in response to incident light, a first capacitance that receives and stores the charges generated in the one or more photoelectric conversion elements, a second capacitance that is connected to the first capacitance via a switch, and a comparator that compares the amount of charges stored in the first capacitance with a predetermined value. The second capacitance is connected to the first capacitance via the switch, and the pixel circuit includes a comparator that compares the amount of the charges stored in the first capacitance with a predetermined value. When the amount of the charges accumulated in the first capacitance in the comparator is greater than the predetermined value, the switch is turned on and the charges are accumulated by the capacitance that is the sum of the first capacitance and the second capacitance.

### TECHNICAL FIELD

The present disclosure relates to pixel circuit for image sensors, particularly with respect to dynamic range extension.

### BACKGROUND INFORMATION

Image sensors using dual conversion gain (DCG) pixels are known as image sensors with expanded dynamic range or high dynamic range (HDR).

This DCG uses an additional capacitance added to the floating diffusion for storing charges generated by photodiodes. The dynamic range can be increased by reading out two types of signals: (i) with no additional capacitance, high conversion gain, and (ii) with additional capacitance, low conversion gain.

Such technology is described in U.S. Pat. No. 8,575,533.

### SUMMARY

The pixel circuit for image sensors in accordance with the present disclosure comprises:
one or more photoelectric conversion elements that generates electric charges in response to incident light,
a first capacitance for receiving and storing the charges generated in the one or more photoelectric conversion elements,
a second capacitance connected to the first capacitance via a switch, and
a comparator that compares the amount of charges stored in the first capacitance with a predetermined value, wherein
when the amount of charges accumulated in the first capacitance in the comparator is greater than a predetermined value, the switch is turned on and the charges is are accumulated by the capacitance that is a sum of the first and second capacitance.

The capacity for storing charges generated by the photoelectric conversion element can be switched adaptively.

### BRIEF DESCRIPTION OF THE DRAWINGS

FIG. 1 shows a configuration of the pixel circuit in the embodiment.

FIG. 2A shows a state of charges accumulated in two pixels at the time of a reset process.

FIG. 2B shows a state of charges accumulated in two pixels at the time of an exposure process.

FIG. 2C shows a state of charges accumulated in two pixels at the time of a transfer process for the left photodiode PDL.

FIG. 2D shows a state of charges accumulated in two pixels at the time of a CG decision process for the left photodiode PDL.

FIG. 2E shows a state of charges accumulated in two pixels where an additional capacitance is added to the floating diffusion FD for a high light pixel and an additional capacitance is not added to the floating diffusion FD for a low light pixel.

FIG. 2F shows a state of charges accumulated in two pixels at the time of a transfer process for the right photodiode PDR.

FIG. 2G shows a state of charges accumulated in two pixels at the time of a read-out process with HCG for low light pixel.

FIG. 2H shows a state of the charges accumulated in two pixels where additional capacitances are added to the floating diffusions FDs of both of the bright pixel and the dark pixel.

FIG. 3 is a timing chart showing the readout operation of the pixel circuit.

FIG. 4 shows the configuration of pixel circuits for other embodiments.

FIG. 5A is a timing chart for the readout operation of the circuit in FIG. 4.

FIG. 5B is a timing chart for the readout operation of the circuit in FIG. 4.

FIG. 5C is a timing chart for the readout operation of the circuit in FIG. 4.

FIG. 6 shows another example of a pixel circuit.

FIG. 7 shows yet another example of a pixel circuit.

FIG. 8 shows yet another example of a pixel circuit.

FIG. 9 shows yet another example of a pixel circuit.

FIG. 10A shows yet another example of a pixel circuit.

FIG. 10B shows yet another example of a pixel circuit.

FIG. 11 shows a timing chart showing the readout operation of the circuit using the judge circuit.

FIG. 12 is a block diagram showing the structure of an image sensor according to the embodiment of the present disclosure.

### DETAILED DESCRIPTION

Hereinafter, an embodiment of the present disclosure will be described with reference to the drawings. Note that the following embodiment does not limit the present disclosure, and configurations obtained by selectively combining multiple examples are also included in the present disclosure.

### Pixel Circuit Configuration

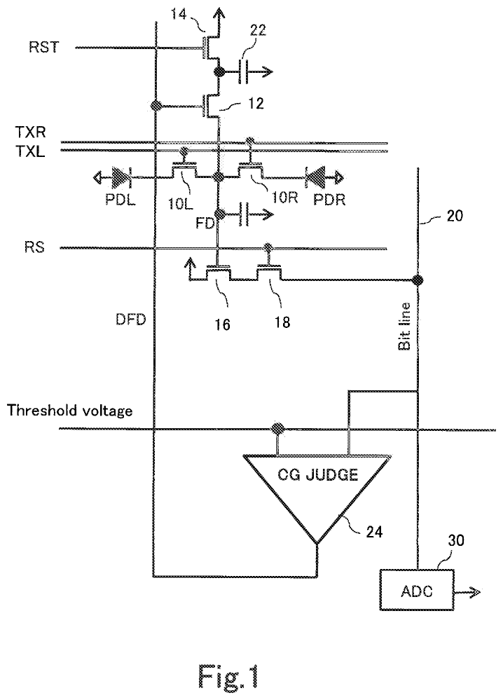

FIG. 1 shows the configuration of the pixel circuit of an image sensor. In this embodiment, one pixel has two photodiodes PDs (PDL, PDR). Photodiode PDL is located on the left side of the pixel, and photodiode PDR is located on the right side of the pixel. The photodiode PD is a photoelectric conversion element that generates charges in response to incident light. In this embodiment, the charges are electrons, which are negative charges.

From the left and right photodiodes PDL and PDR, signals can be obtained separately to obtain phase information for autofocusing. The pixels shown in FIG. 1 are arranged in a matrix to form an image sensor, and a reset, exposure, and readout can be performed for multiple pixels in a row at the same time in the same manner. The charges generated by the photodiode PDL are called the first charges, and the charges generated by the photodiode PDR are called the second charges.

Photodiode PDL is connected to floating diffusion FD via transistor 10L, and photodiode PDR is connected to floating diffusion FD via transistor 10R. The gate of transistor 10L is connected to the transfer control line TXL, and the gate of transistor 10R is connected to the transfer control line TXR. Therefore, by setting the transfer control line TXL to high (H) level (ON), the transistor 10L turns on and the charges stored in the photodiode PDL are transferred to the floating diffusion FD. Also, by setting the transfer control line TXR to high (H) level (ON), transistor 10R is turned on and the charges stored in photodiode PDR are transferred to floating diffusion FD. The floating diffusion FD is a capacitance that stores the charges and is called the first capacitance. The other end of the floating diffusion FD is set at an appropriate voltage.

The gate of the source follower transistor 16 is connected to the floating diffusion FD. The drain of the source follower transistor 16 is connected to the power supply and the source is connected to the drain of the row select transistor 18. The gate of the row selection transistor 18 is connected to the row selection line RS and the source is connected to the bit line 20. Therefore, when the row selection line RS is at a high level (ON), the row selection transistor 18 is turned on and the voltage corresponding to the voltage of the floating diffusion FD is read out to the bit line 20.

ADC (Analog Digital Converter) 30 is connected to bit line 20, and converts the analog signal of the bit line to a digital signal. The digital signal after AD conversion, which is the output of ADC 30, is output as an image signal. One ADC 30 may be provided for each column, or an ADC 30 may be provided for each pixel in which case digital signals may be output from each pixel.

The source of transistor 12 is connected to the floating diffusion FD, and an additional capacitance 22 is connected to the drain of transistor 12. The other end of the additional capacitance 22 is connected to a power source such as ground. Note that the additional capacitance 22 is referred to as the second capacitance. The transistor 12 functions as a switch that controls whether or not the additional capacitance 22 is added to the floating diffusion FD.

The gate of transistor 12 is connected to control line DFD. Therefore, by setting the control line DFD to H level (ON), the transistor 12 is turned on and the additional capacitance 22 is added to the capacitance of the floating diffusion FD.

The drain of transistor 12 is connected to the power supply through reset transistor 14. The gate of the reset transistor 14 is connected to the reset line RST (hereinafter reset line RST may be referred to as RST).

With transistor 12 turned on, the additional capacitance 22 and floating diffusion FD can be reset by setting the reset line RST to H level (ON). When the reset line RST is set to H level (ON) with the transistor 12 turned off, only the additional capacitance 22 is reset.

This system has a CG judge circuit 24 that makes a judgment to determine the conversion gain CG, which represents the magnitude of the output voltage relative to the amount of incident light (=amount of generated charges) The CG judge circuit 24 compares the voltage of the bit line 20, which is the voltage of the floating diffusion FD provided via the source follower transistor 16, with a threshold voltage (predetermined value). The CG judge circuit 24 functions as a comparator.

In this system, the charge stored in the floating diffusion FD is electrons, and the greater the amount of charges, the lower the voltage of the floating diffusion FD. Therefore, a voltage on bit line 20 below the threshold voltage means that there is a large amount of stored charges in the floating diffusion FD.

Whether or not the additional capacitance 22 is added to the floating diffusion FD is determined by the decision of the CG judge circuit. If the voltage of the bit line 20 (corresponding to the voltage of the floating diffusion FD) is lower than the threshold voltage, the additional capacitance 22 is added to the floating diffusion FD. If the voltage of the bit line 20 (corresponding to the voltage of the floating diffusion FD) is higher than the threshold voltage, the additional capacitance 22 is not added to the floating diffusion FD.

If the additional capacitance 22 is added, the absolute voltage for a certain amount of stored charges is smaller (the voltage of the floating diffusion FD is higher), and therefore the conversion gain CG becomes small. This condition is called low conversion gain LCG. If additional capacitance 22 is not added, the absolute voltage for a certain amount of stored charges becomes larger (the voltage of the floating diffusion FD is lower). This state is called high conversion gain HCG.

One input end of the CG judge circuit 24 is connected to the bit line 20, and the threshold voltage (=predetermined value) is supplied to the other input end. The output of the CG judge circuit 24 is connected to the gate of the transistor 12 via the control line DFD. The CG judge circuit 24 outputs an L level signal initially. The CG judge circuit 24 outputs an H level signal when the signal on bit line 20 is below the threshold voltage. Therefore, when a voltage of the signal on bit line 20 is below the threshold voltage, transistor 12 is turned on and additional capacitance 22 is added to the floating diffusion FD. Therefore, the LCG state is such that the voltage change with respect to the stored charges is small. When a voltage of the signal on bit line 20 is more than the threshold voltage, transistor 12 turns off and the additional capacitance 22 is not added to the floating diffusion FD. Therefore, the HCG state with a large voltage change with respect to the stored charges is set.

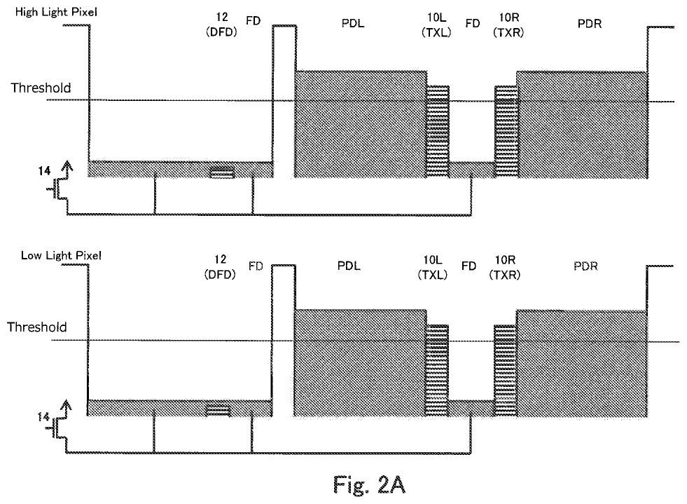

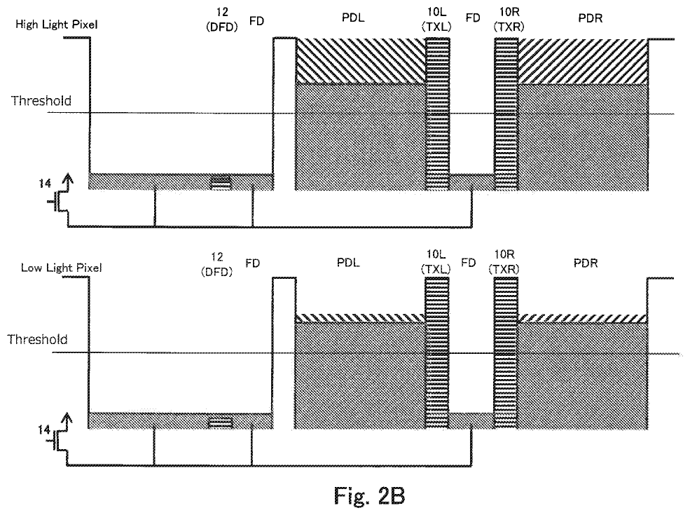

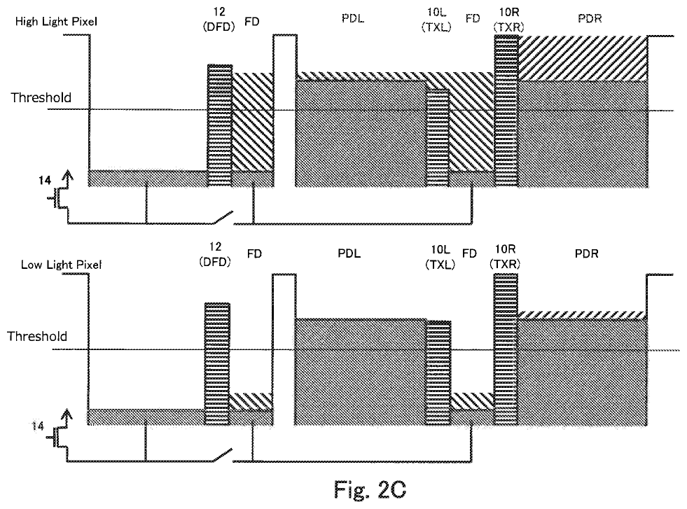

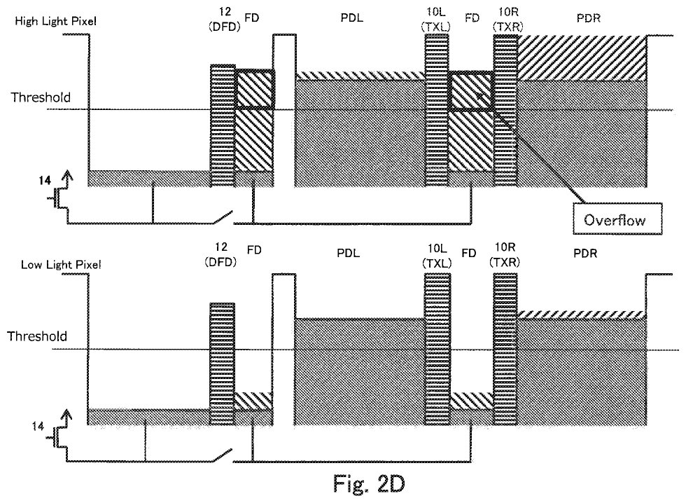

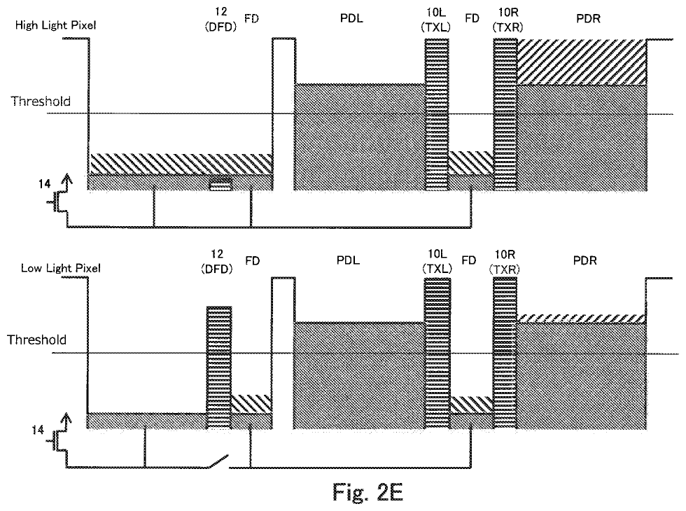

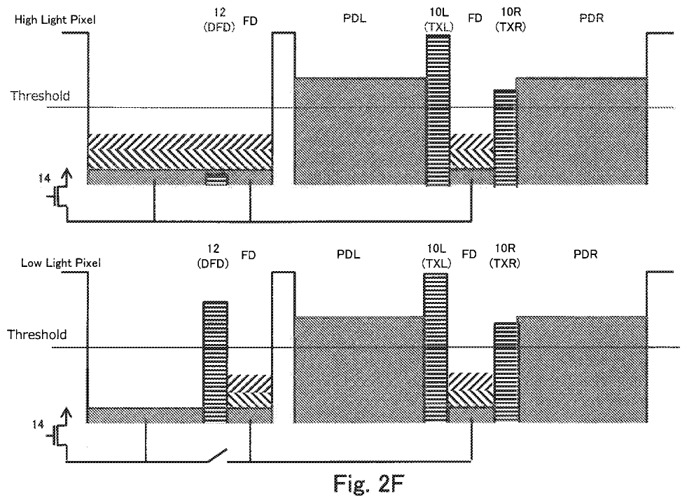

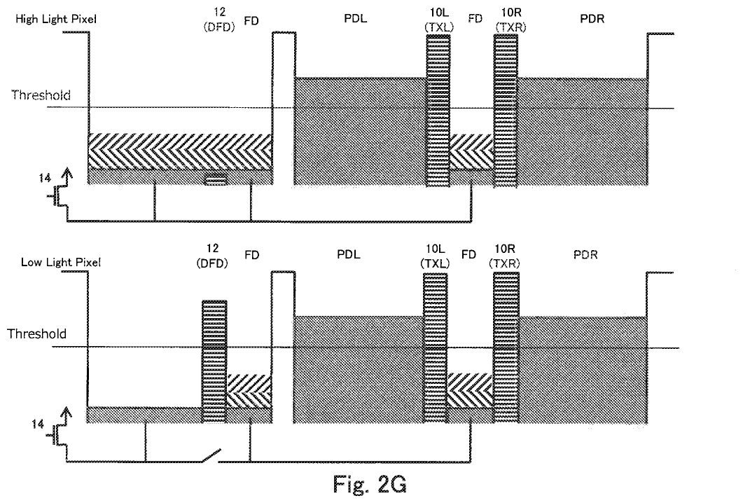

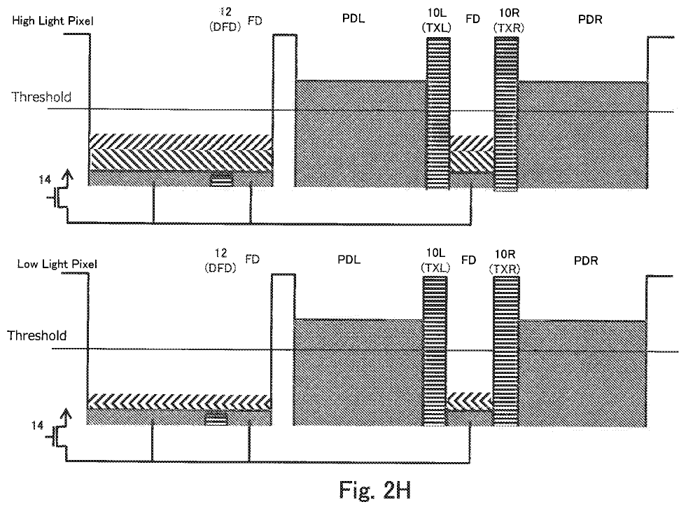

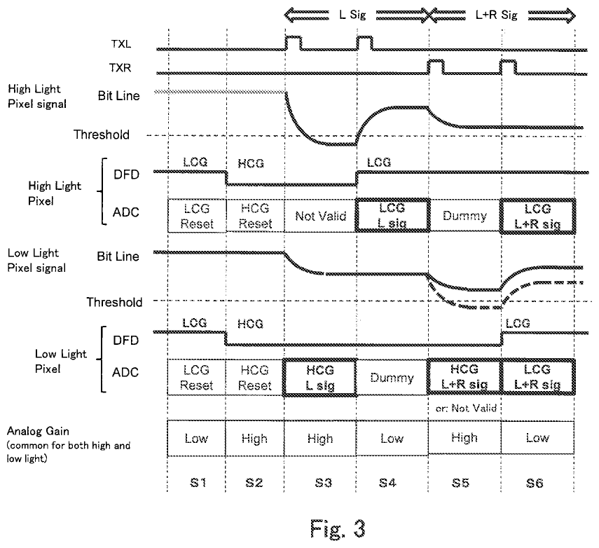

FIGS. 2A-2H show charge accumulation states at various parts of the pixel for each process. FIG. 3 is a timing chart showing the readout operation of the pixel circuit.

FIG. 2A shows the reset process. With transistor 12 on, reset transistor 14 is turned on to reset floating diffusion FD and additional capacitance 22. As shown in FIG. 2A, both transfer transistors 10L and 10R are on, and the charges of photodiodes PDL and PDR are also reset.

Next, the exposure step is performed. In the exposure step, row selection transistor 18, and transfer transistors 10L and 10R are turned off. This causes the photodiodes PDL and PDR to accumulate charges in accordance with the incident light intensity.

FIG. 2B shows the exposure step completed. More charges are accumulated in the high light pixels and less in the low light pixels. In this case, an additional capacitance 22 is being added to the floating diffusion FD.

When the exposure step is completed, the readout step is performed. In the read step, the row selection transistor 18 is turned on to make the bit line 20 correspond to the voltage of the floating diffusion FD.

As shown in S1 of FIG. 3. The RST and DFD are turned ON to reset both FD and additional capacitance 22. After that reset, RST is turned off. In the LCG state with transistor 12 is turned on and the additional capacitance 22 is added to the floating diffusion FD. Next, as shown in S2 of FIG. 3, first transistor 12 is turned off and in the HCG state where the additional capacitance 22 is not added to the floating diffusion FD. In that manner, the reset levels of the pixel with both HCG and LCG are read.

Next, in the HCG state with transistor 12 turned off, transistor 10L is turned on to transfer the charges of the left photodiode PDL to the floating diffusion FD to which the additional capacitance 22 has not been added.

Here, in the upper high light pixel in FIG. 2D, the floating diffusion FD alone is unable to fully accommodate the charges of the photodiode PDL and overflows. In the low light pixels, the floating diffusion FD is able to accommodate the charges of the PDL.

In this condition, the voltage on bit line 20 for the high light pixel exceeds the threshold voltage of CG judge circuit 24, as shown in S3 in FIG. 3. Therefore, for high light pixels, the output of ADC 30 is disabled (Not Valid). On the other hand, for low light pixels, the output in the HCG stage is obtained from the ADC 30, and the signal L-sig at HCG is output for the incident light level of the left photodiode PDL.

In FIG. 2D, the voltage on bit line 20 for the high light pixel is below the threshold voltage. Therefore, an H-level signal is output from CG Judge Circuit 24 for the high light pixel.

Thus, transistor 12 turns on. This adds an additional capacitance 22 to the floating diffusion FD, as shown in FIG. 2E. Therefore, the floating diffusion FD is shifted to the LCG state and the voltage of the floating diffusion FD is higher (the charges stored in the floating diffusion FD is smaller).

Then, as shown in S4 of FIG. 3, ADC 30 performs AD conversion on the lower voltage and outputs the signal Lsig at LCG for the amount of stored charges in photodiode PDL.

Note that low light pixels do not need to output signals since they have already been read out. In this embodiment, the conversion gain for the voltage of each of the bit line 20 (input of each of ADCs 30) is determined separately. The analog gain is the same for ADCs 30 in one row. In S4 of FIG. 3, the ADC 30 of the low light pixel is not appropriate for AD conversion at LCG and the step for the low light pixel should be a dummy operation.

When the accumulated charges of the left photodiode PDL have been read out, the transfer transistor 10R is turned on and the accumulated charges of the right photodiode PDR are transferred to the floating diffusion FD, as shown in FIG. 2F.

In high light pixels, the charges accumulated in the photodiodes PDL and PDR on both the left and right sides are accumulated (or summed) in the floating diffusion FD with an additional capacitance of 22 in the LCG state. In low light pixels, the charges accumulated in the photodiodes PDL and PDR on both the left and right sides are accumulated (or summed) in the floating diffusion FD in the HCG state.

As shown in S5 of FIG. 3, AD conversion with HCG is performed in ADC 30 for low light pixels, and L+R sig in the HCG state is output. On the other hand, in high light pixels, the high analog gain of ADC 30 is not appropriate and a dummy operation is performed.

Next, as shown in FIG. 2H, in low light pixels, transistor 12 is turned on. This causes the pixel enter in the LCG state and the overall capacity for charges at the floating diffusion FD becomes larger and the voltage of the floating diffusion FD is raised (the voltage change becomes smaller). In this way, both the high light pixel and the low light pixel enter in the LCG state, AD conversion at LCG is performed in ADC 30, and the L+Rsig in the LCG state is output from both the high light pixel and the low light pixel.

In this embodiment, no overflow occurs in low light pixels in FIG. 2F, and therefore, the L+Rsig at HCG in S5 of FIG. 3 is considered more accurate than the L+Rsig at LCG in S6. Therefore, it is recommended that HCG L+Rsig be used in the latter stage.

In this way, the signal L sig corresponding to the incident light intensity of the left photodiode PDL and the signal L+Rsig corresponding to the total incident light intensity of the photodiodes PDL and PDR on both the left and right sides are output from ADC 30 while changing the conversion gain as appropriate.

Here, as mentioned above, in the example shown in FIG. 2G even in low light pixels and in the HCG state with transistor 12 turned off, the voltage corresponding to the total amount of stored charges of the photodiodes PDL and PDR on both left and right sides does not exceed the threshold voltage. Therefore, it is not necessary to turn on transistor 12. However, as shown by the dashed line in S5 of FIG. 3, the voltage for the total amount of charges on the left and right sides may exceed the threshold voltage.

In this case, in low light pixels, the L+Rsig at HCG in S5 in FIG. 3 should be invalidated and the L+Rsig at LCG in S6 should be adopted.

In this way, the addition of additional capacitance to the floating diffusion FD can be adaptively controlled for high light pixels and low light pixels according to the incident light intensity, thereby increasing the dynamic range while also maintaining high detection accuracy for the incident light intensity of low light pixels.

### Other Example of Pixel Circuit

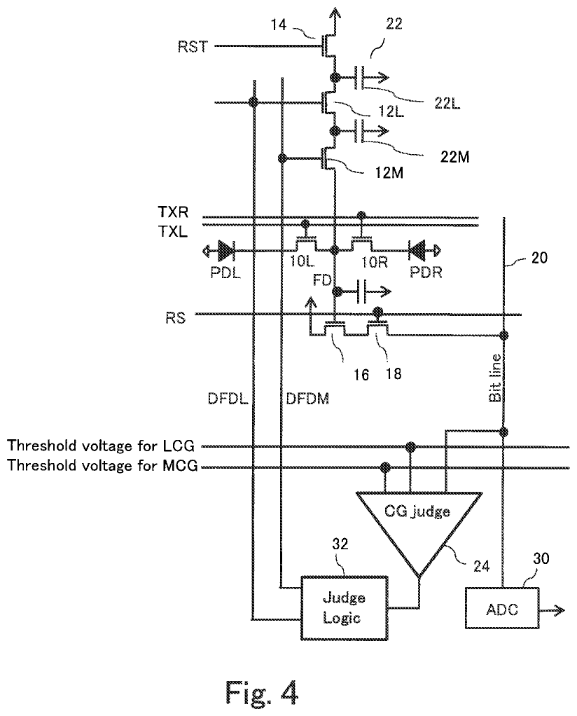

FIG. 4 shows the configuration of a pixel circuit for another embodiment. In this example, there are two additional capacitances, 22L and 22M, as capacitances to be added to the floating diffusion FD, and a judge logic circuit 32 that controls the addition of the additional capacitances 22L and 22M using the output of the CG judge circuit 24.

In this embodiment, two threshold voltages, i.e. Threshold voltage for LCG and threshold voltage for medium conversion gain MCG are input to the CG judge circuit 24. The CG judge circuit 24 compares the voltage on the bit line 20 with both of the two threshold voltages.

Two transistors 12L and 12M are provided between the reset transistor 14 and the floating diffusion FD. An additional capacitance 22M is connected to the connection point of transistor 12M and transistor 12L, and an additional capacitance 22L is connected to the connection point of transistor 12L and reset transistor 14.

Therefore, by turning on transistor 12M, additional capacitance 22M is added to the floating diffusion FD, and by turning on both transistors 12M and 12L, both additional capacitances 22M and 22L are added to the floating diffusion FD. Therefore, the capacitance of the floating diffusion FD becomes (i) no addition which maintains HCG, (ii) addition of additional capacitance of 22M which leads to MCG, and (iii) addition of additional capacitance of 22M and 22L which provides LCG. The same method can also be used to set the capacity of floating diffusion FDs to four or more levels.

The judge results of the CG judge circuit 24 is input to the judge logic circuit 32. The judge results include the result using the threshold voltage for LGC and the threshold voltage for MCG. The judge logic circuit 32 outputs signals on two lines, namely the control line DFDM and the control line DFDL. Control line DFDM is connected to the gate of transistor 12M, and control line DFDL is connected to the gate of transistor 12L, and the on/off states of these transistors are controlled to control the additional capacitance to the floating diffusion FD.

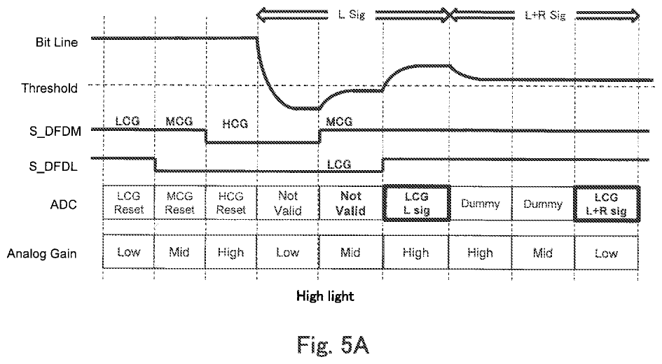

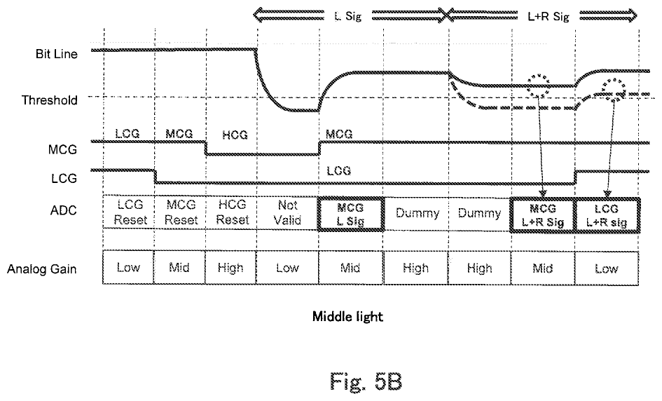

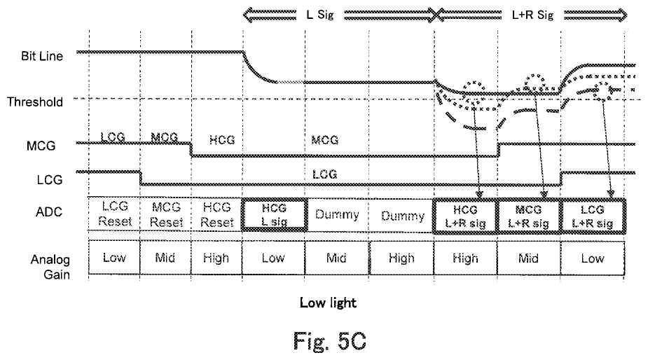

FIGS. 5A-5C show a timing chart for the readout operation of the circuit in FIG. 4. First, the output of the ADC 30 in the three states of no additional capacitance (HCG), additional capacitance 22M only (MCG), and additional capacitance 22M and 22L (LCG) is reset. Then, the readout is sequentially switched to LCG, MCG, and HCG.

That is, with the reset transistor 14 turned off, transistors 12L and 12M are sequentially turned off and the additional capacitances 22L and 22M are sequentially disconnected from the floating diffusion FD.

This allows readout in three steps with respect to the amount of stored charges. The example in FIG. 5A is for a high light pixel. In this example, two readouts at LCG, i.e. LCG-Lsig and LCG-L+Rsig, are employed.

The example in FIG. 5B is for middle light pixels. In this example, two readouts at MCG, i.e. MCG-Lsig and MCG-L+Rsig or two readouts at MCG and LCG, i.e. MCG-Lsig and LCG-L+Rsig, are employed

The example in FIG. 5C is for low light pixels. In this example, two readouts at HCG, i.e. HCG-Lsig, HCG-L+Rsig, or two readouts at HCG and MCG, i.e. HCG-Lsig, MCG-L+Rsig, or two readouts at HCG and LCG, i.e. HCG-Lsig, and LCG-L+Rsig are employed.

By increasing the number of additional capacitance switches, the additional capacitance setting for the floating diffusion FD can be fine-tuned, resulting in more accurate readout.

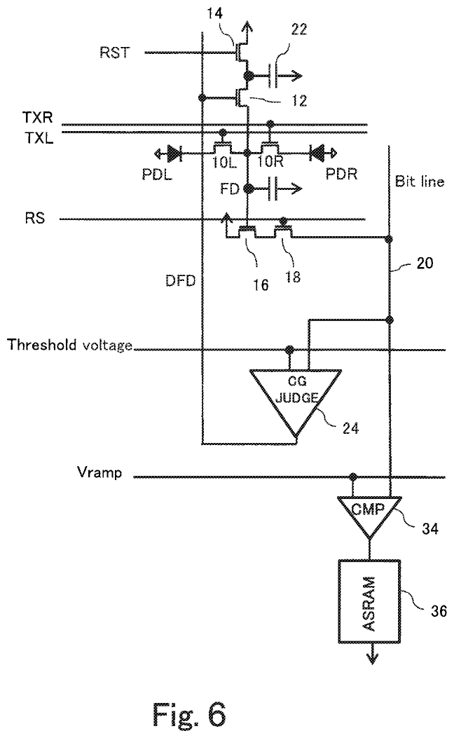

FIG. 6 shows another example of a pixel circuit. This example has a comparator (CMP) 34. The bit line 20 is connected to one input end of this comparator 34, and the ramp signal Vramp is input to the other input end. The ramp signal Vramp is a saw tooth wave signal whose voltage rises linearly and returns to zero. Therefore, the voltage on bit line 20 is compared with the ramp signal, and the result of determining at what point the ramp signal exceeds the voltage on bit line 20 is obtained at the output of comparator 34.

The output of comparator 34 is connected to ASRAM 36, where data about the time at which the output of comparator 34 is switched, i.e., the AD-converted voltage on bit line 20, is written.

Thus, the comparator 34 can be employed in place of the ADC 30.

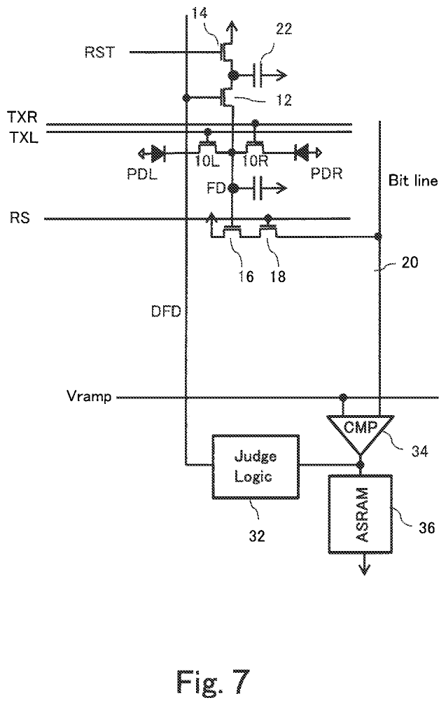

FIG. 7 shows yet another example of a pixel circuit. In this example, the CG judge circuit 24 in the circuit of FIG. 6 is omitted and the output of comparator 34 is used as the signal to turn transistor 12 on and off. Vramp is set to the threshold voltage, CMP 34 is used as CG judge circuit. The judge logic circuit 32 memorizes the judgement result of CMP 34 and controls DFD in CG judgement phase. That is, transistor 12 is turned on when the voltage of bit line 20 is above the voltage of the ramp signal Vramp. In addition, the control line DFD may be changed to control lines DFDL and DFDM and include capacitances 22L and 22M as described in FIG. 4.

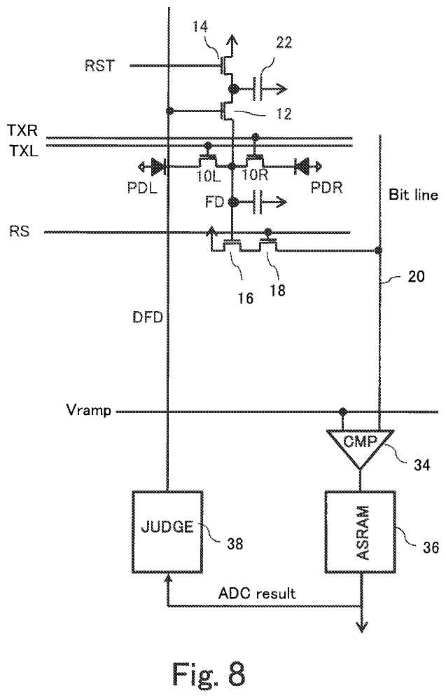

FIG. 8 shows yet another example of a pixel circuit. In this example, the voltage value of bit line 20 written to ASRAM 36 is input to judge circuit 38. The judge circuit 38 turns on the transistor 12 when the input value is higher than the voltage of ramp signal Vramp.

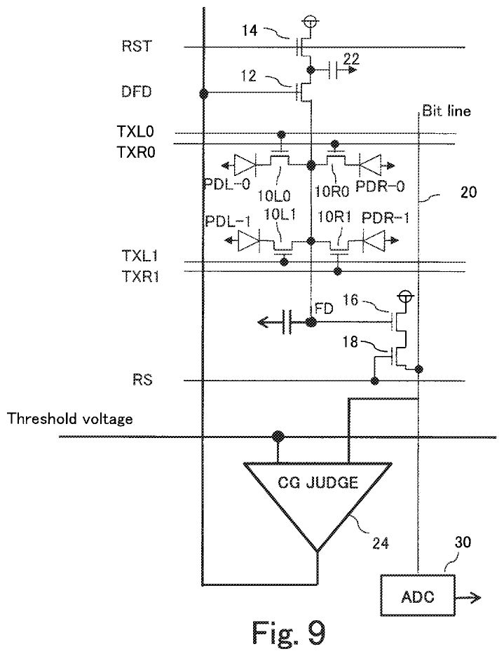

FIG. 9 shows yet another example of a pixel circuit. In this example, for one pixel, there are four photodiodes PDL0, PDR0, PDL1, PDR1, and four transistors 10L0, 10R0, 10L1, 10R1, which can transfer the charges from each photodiode separately to the floating diffusion FD.

With this configuration, a total of four sub-pixels can be provided for one pixel, namely two on the left and right, and two on the top and bottom. Therefore, by obtaining signals from the sub-pixels, high-precision phase detection can be performed and high-precision autofocus control can be performed.

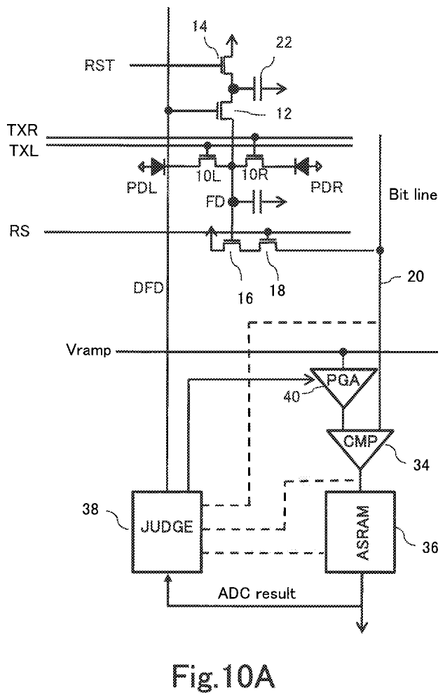

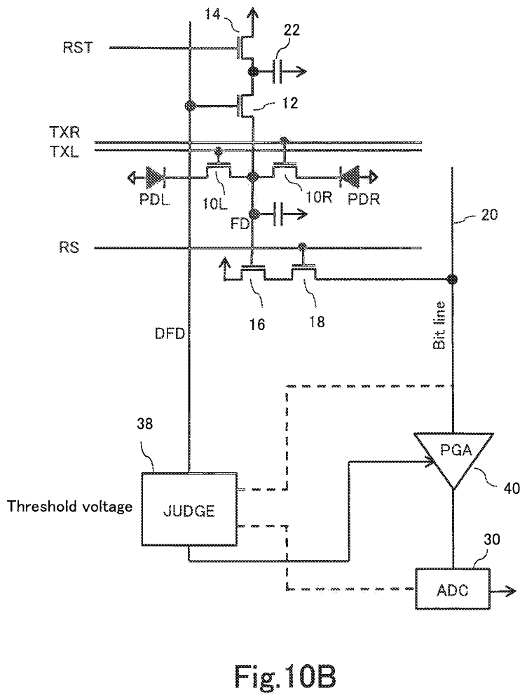

FIGS. 10A and 10B show yet another examples of a pixel circuit. In the above examples, the gain of the ADC 30 in the same row is the same. However, the gain of ADC 30 can be switched for each pixel. This eliminates the dummy operation and reduces the readout time. FIGS. 10A and 10B show examples that the gain of ADC 30 can be switched for each column.

The pixel configuration of FIG. 10A is based on the configuration of the pixel of FIG. 8 by adding a programmable gain amplifier (PGA) 40. The PGA 40 is placed in the input path of the ramp signal Vramp to the comparator 34. Therefore, the amplitude of the ramp signal Vramp can be changed by the programmable gain amplifier 40 to control the decision result of comparator 34. With this configuration, setting the ramp signal Vramp to a predetermined small amplitude corresponds to high analog gain, and setting the ramp signal Vramp to a predetermined large amplitude corresponds to low analog gain.

In the embodiments above, the judge circuit 38 uses three input signals, (i) the voltage of the bit line 20, (ii) the comparing result of the CMP 34, and (iii) the result of the ADC 30. The dotted lines in FIG. 10A show the three examples above.

The pixel configuration of FIG. 10B is based on the configuration of the pixel of FIG. 1 by adding a programmable gain amplifier (PGA) 40. The judge circuit 38 of FIG. 10B corresponds to the CG judge circuit 24 of FIG. 1. The PGA 40 is placed in the input path of the signal from the bit line 20 to the ADC 30. Therefore, as a result at its output, the PGA 40 can change magnitude of the signal on bit line 20, thereby setting the magnitude of the input signal of the ADC 30 to predetermined levels.

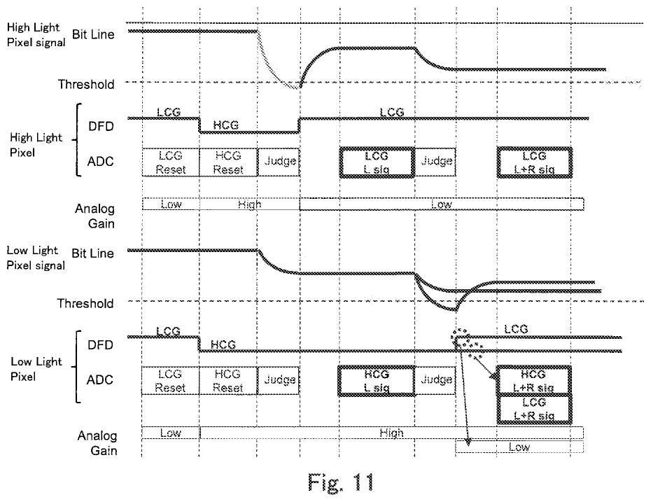

With this configuration, the amplification factor of the programmable gain amplifier 40 is set to high level (marked as “High” for signal “Analog gain” in FIG. 11) in the HCG state, and the amplification factor of the programmable gain amplifier 40 is set to low in the LCG state. FIG. 11 is a timing chart showing the readout operation of the pixel circuit. FIG. 11 corresponds to FIG. 3. As to high light pixel, both LCG-Lsig and LCG-L+Rsig are obtained. As to low light pixel, HCG-Lsig and HCG-L+Rsig or LCG-L+Rsig are obtained. The dummy operation is omitted at both of high light pixel and low light pixel.

### Image Sensor System

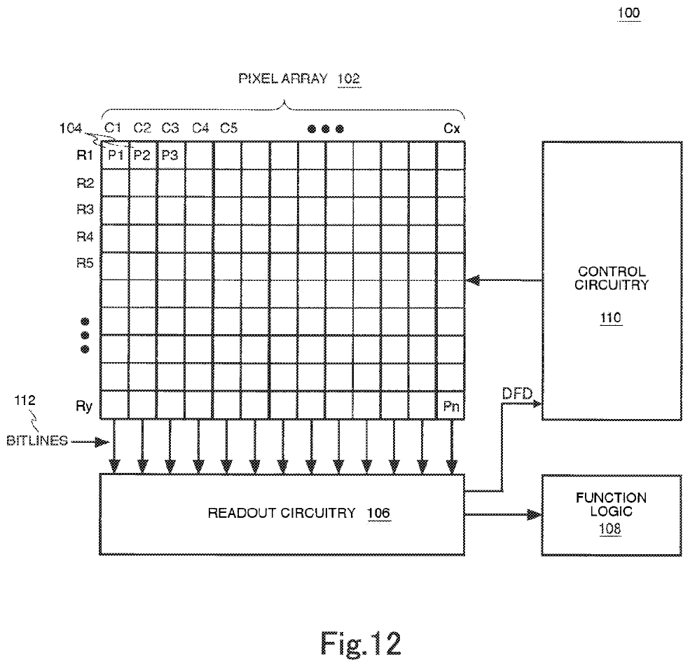

FIG. 12 is a block diagram showing one example of an imaging system 100 including a color pixel array 102 with an array of photodiodes including phase detection autofocus photodiodes interspersed among binned (L+R) image sensing photodiodes in accordance with an embodiment of the present disclosure. In particular, the imaging system 100 includes pixel array 102, control circuitry 110, readout circuitry 106, and function logic 108. In one example, pixel array 102 is a two-dimensional (2D) array of photodiodes, (e.g., P1, P2 to Pn), which include phase detection autofocus photodiodes interspersed among binned (L+R) image sensing photodiodes. As will described in further detail below, in various examples at least some of the transfer transistors coupled to the phase detection autofocus photodiodes may be controlled separately from the image sensing photodiodes in the same row of the array of photodiodes 104. As illustrated in the depicted example, pixels 104 are arranged into rows (e.g., R1 to Ry) and columns (e.g., C1 to Cx) to acquire image data of a person, place, object, etc., which can then be used to render a 2D image of the person, place, object, etc. In the examples, the phase detection autofocus photodiodes interspersed in the pixel array 102 provide phase detection information, which can be used for autofocus operations of imaging system 100.

In one example, after each image sensor photodiode/pixel 104 in pixel array 102 has acquired its image charge or phase detection charge through photogenerated charges, corresponding image data and/or phase detection charge is read out by a readout circuit through bit lines 112 and then transferred to function logic 108. Readout circuitry 106 may be coupled to read out data from the plurality of pixels 104 in the pixel array 102. In various examples, the readout circuitry 106 may include amplification circuitry, analog-to-digital (ADC) conversion circuitry, judge circuit (that outputs to control circuitry 110), or otherwise. In one example, the readout circuitry 106 may read out a row of data at a time along bit lines 112 as illustrated in FIG. 12. The function logic 108 may store the image data or even manipulate the image data by applying post image effects (e.g., crop, rotate, remove red eye, adjust brightness, adjust contrast, or otherwise).

What is claimed is:

1. A pixel circuit for an image sensor, comprising:
a first photoelectric conversion element that generates electric charges in response to incident light, wherein the generated electric charges form first charges;
a first capacitance for receiving and storing the first charges;
a second capacitance connected to the first capacitance via a switch; and
a comparator that compares an amount of charges stored in the first capacitance with a predetermined value, wherein when the amount of charges stored in the first capacitance is greater than the predetermined value, the switch is turned on and the generated charges are stored in both the first capacitance and the second capacitance with a combined capacitance being a sum of the first capacitance and the second capacitance.

2. A pixel circuit of claim 1, wherein the comparator reads out a voltage associated with the first charges stored in the first capacitance and compares the readout voltage with the predetermined value.

3. A pixel circuit of claim 1, further comprising:
a second photoelectric conversion element that generates electric charges in response to incident light, wherein the generated electric charges form second charges, and wherein the amount of charges stored in the first capacitance is a sum of the first charges and the second charges.

4. A pixel circuit for an image sensor, comprising:
a first photoelectric conversion element that generates electric charges in response to incident light, wherein the generated electric charges form first charges;
a first capacitance for receiving and storing the first charges;
a second capacitance connected to the first capacitance via a first switch;
a third capacitance connected to the second capacitance via a second switch; and
a comparator that compares an amount of charges stored in the first capacitance with a first predetermined value, wherein when the amount of charges stored in the first capacitance is greater than the first predetermined value, the first switch is turned on and the generated charges are stored in the first capacitance and the second capacitance with a combined capacitance being a sum of the first capacitance and the second capacitance, and wherein when the amount of charges stored in the first capacitance is greater than a second predetermined value, both the first switch and the second switch are turned on and the generated charges are stored in the first capacitance, the second capacitance, and the third capacitance with a combined capacitance being a sum of the first capacitance, the second capacitance, and the third capacitance.

5. A pixel circuit of claim 4, wherein the comparator reads out a voltage associated with the charges stored in the first capacitance and compares the readout voltage with one of the first and the second predetermined values.

6. A pixel circuit of claim 4, further comprising:
a second photoelectric conversion element that generates electric charges in response to incident light, wherein the generated electric charges form second charges, and wherein the amount of charges stored in the first capacitance is a sum of the first charges and the second charges.
